(19) United States
(12) Patent Application Publication
(10) Pub. No.: US 2009/0210329 A1
(43) Pub. Date: Aug. 20, 2009

(54) Renewable Energy Park

(76) Inventor: Rovshan Sade, Raleigh, NC (US)

Correspondence Address: COATS & BENNETT, PLLC, 1400 Crescent Green, Suite 300, Cary, NC, 27518, US

(21) Appl. No.: 12/399,257

(22) Filed: Mar. 6, 2009

Related U.S. Application Data
(63) Continuation-in-part of application No. 12/033,477, filed on Feb. 19, 2008.

(51) Int. Cl. G06Q 10/00

(52) U.S. Cl. 705/30

(57) ABSTRACT

A renewable energy park comprises a large-scale power generation facility having a plurality of individual power generation units for generating power from a renewable energy source. Individual power generation units are sold or leased to private investors. Energy supplied by individual power generation units in the renewable energy park to a public power grid is measured so that the individual investors can receive a retail offset or other form of payment for the energy produced.

### RELATED APPLICATION

This is a continuation-in-part of U.S. patent application Ser. No. 12/033,477 filed Feb. 19, 2008, which is incorporated herein by reference.

### BACKGROUND

The present invention relates generally to the generation of electricity from alternative energy sources and, more particularly, to a renewable energy park including a plurality of individually owned or leased power generation units.

On-going conflict in the Middle East, concerns for global warming, and rising oil prices are fueling the push for renewable energy sources such as wind and solar power. Today, approximately 70% of the electricity generated in the United States is produced by burning fossil fuels, such as coal, natural gas, and petroleum. Another 19% is produced from nuclear power and approximately 1% is produced from hydroelectric power. Energy produced from alternative energy sources, such as wind and solar power, account for less than 1% of the total electricity produced in the United States. Our reliance on fossil fuels and nuclear power has several drawbacks. While fossil fuels are comparatively inexpensive, there is only a limited supply of fossil fuels, which will eventually be depleted if alternative energy sources are not found. Further, the burning of fossil fuels to produce electricity emits greenhouse gases that contribute to global warming. The main problem with nuclear power is how to dispose of hazardous waste.

Solar energy and wind power are promising alternative energy sources that can reduce reliance on fossil fuels for generating electricity. Solar energy and wind power are renewable resources so there is no concern about future depletion of these resources. Further, the generation of electricity from solar energy and wind power does not emit greenhouse gases and is therefore considered more environmentally friendly. Also, generation of electricity from renewable energy sources does not generate hazardous by-products that need to be disposed.

While solar energy and wind power are more affordable today than ever before, these renewable energy resources have their drawbacks. Because solar energy and wind power are very diffuse energy sources, renewable power generation facilities are typically characterized by a large number of individual generation units that are spread over a large land area. Consequently, solar and wind power facilities tend to be more costly to build and operate, and the electricity produced from these facilities is more costly to consumers.

Accordingly, there is a need for improved methods for operating of renewable power facilities that reduce the cost of electricity produced by such facilities.

### SUMMARY

The present invention relates to a renewable energy park (REP). The REP comprises a large scale renewable power generation facility including a plurality of renewable power generation units for generating power from renewable energy sources, such of the sun or wind. Operation and maintenance of the power generation units may be commonly managed by the operating company. Individual investors can lease or purchase individual power generation units at the power generation facility. The individual power generation units are connected to a public power grid to provide energy produced by the REP to the public grid. Power contributed by each individual power generation unit is separately measured to enable the individual investors to receive a payment or other economic benefit for the power contributed to the public grid by their respective power generation units. The payment may take the form of a credit applied to reduce the owners' electricity bills and appear on billing statements from the public utility companies. Payments can also take the form of direct payments or dividends to the individual investors.

According to one exemplary embodiment, the operating company enters into a master power purchase agreement with the utility company. The master PPA provides that the utility company will receive all or part of the power generated for a specified period (typically 20 to 25 years). In exchange, the utility company agrees to pay a specified price for the power. The operating company can subsequently transfer rights in individual power generation units to individual investors through a lease or sale. At the time of the transfer, the operating company also enters into a sub-PPA with the investor to purchase the power generated by the PGU from the investor. The sub-PPA guarantees the investor 16 a specified retail offset for the power generated from the PGUs 52. The PPA and sub-PPA also provide a guarantee to the investor 16 of a predetermined return on the investment in the PGU 52.

In one embodiment, the operating company can enter into a lease/purchase agreement with the investor that gives the investor the option to purchase the power generation unit at the end of the lease term. The lease term is set to enable the operating company to fully realize depreciation and other tax benefits. The purchase price in the lease is set to provide an acceptable return on investment to the investor.

In another embodiment, the utility company can construct the REP and lease or sell the power generation units directly to individual investors to recoup its capital costs.

The REP enables ordinary consumers to invest in renewable energy. The investors benefit from the economies of scale of a large-scale power generation facility and from the cost savings due to tax credits and depreciation that can be passed to the investors through the sub-PPAs. Investors can purchase as many individual power generation units as they want to provide all or part of their energy needs. Further, the investor is not burdened with engineering and maintenance of the energy generating assets.

The public utility companies also benefit by gaining access to renewable energy that diversifies their power portfolios and provides renewable energy credits (RECs) to meet Renewable Portfolio Standard (RPS) requirements at a lower cost than alternative project execution methods. In embodiments where the renewable power generation facility is fully funded by private investors, the utility company can gain access to RECs without up-front investment in the REP. In the case of solar power facilities, the generating assets are highly efficient during peak hours.

### BRIEF DESCRIPTION OF THE DRAWINGS

FIG. 1 illustrates an exemplary renewable energy park.

FIG. 2 illustrates entities involved in the operation of the renewable energy park in a first embodiment.

FIG. 3 illustrates entities involved in the operation of the renewable energy park in a second embodiment.

FIG. 4 illustrates the comparative costs of a power generation unit purchased at retail with a power generating unit in a renewable energy park.

FIG. 5 illustrates an exemplary method for operating a renewable power generation facility by an operating company.

FIG. 6 illustrates another exemplary method for operating a renewable energy park by a utility company.

### DETAILED DESCRIPTION

Referring now to the drawings, an exemplary renewable energy park (REP) 50 is shown. The REP 50 is a large-scale power generation facility (e.g., a large scale solar or wind farm) having a plurality of individual power generation units (PGUs) 52 that can be individually sold or leased as hereinafter described. The PGUs 52 are preferably located at the same site and are commonly managed. The REP 50 may, for example, comprise a solar, wind, or geothermal REP.

The REP 50 connects and provides power to the public power grid 56. In one exemplary embodiment, the individual PGU 52s are connected to a power grid 56 through an aggregator 58 that aggregates power from all of the PGUs 52. Individual power meters 54 for each PGU 52 tracking the amount of power contributed by corresponding PGUs 52 to the power grid 56. The power meters 54 connect to a central computer 62 for tracking the amount of power produced and contributed by each PGU 52. This is useful not only for accounting purposes, but also to monitor performance of the PGUs 52 and to detect when a PGU 52 needs servicing. The central computer 62 may provide a power report to an accounting server 64 that handles accounting functions as will be hereinafter described in greater detail. Alternatively, the central computer 62 could also function as the accounting server 64.

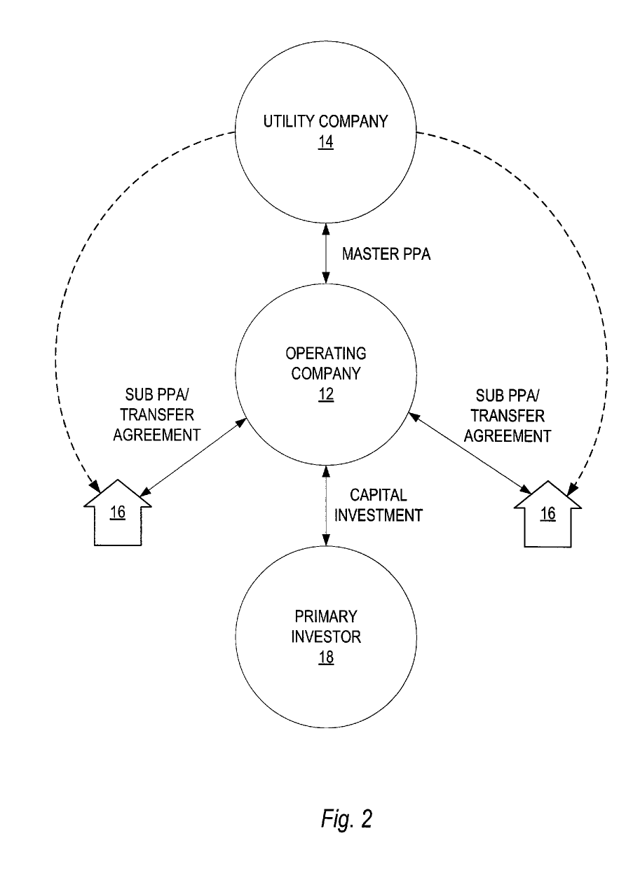

FIG. 2 illustrates various entities involved in the operation of the REP 50. The entities comprise an operating company 12 that operates the REP 50, a utility company 14 that controls a public power grid 56 that provides electrical power to consumers and businesses, and a plurality of investors 16 that purchase or lease rights in individual PGUs 52. The investors 16 may, for example, comprise homeowners or business owners that have homes or businesses connected to the public power grid 56. The operating company 12 may receive initial capital for the project from a primary investor 18, such as a bank, financial institute, or investment group.

The operating company 12 may construct and initially own the REP 50 and all of the PGUs 52. The operating company 12 enters into a master power purchase agreement (PPA) with the utility company 14 to provide power generated by the individual PGUs 52 in the REP 50 to the grid 56 at market prices. The PPA gives the utility company 14 the right to all or a specified portion of the power generated by the REP 50. The PPA also gives the utility company 14 the right to all or a specified portion of the Renewable Energy Credits (RECs) generated by the REP 50. In exchange, the utility company 12 agrees to pay a specified purchase price for the generated power over the term of the PPA, which may be as long as 20 to 25 years. The price may be fixed for the term of the PPA, or may be indexed to inflation.

The operating company 12 may transfer rights in individual PGUs 52 to the investors 16. For example, the investors 16 may purchase or lease individual PGUs 52 in the REP 50 from the operating company 12. The PGUs 52 can be sold or leased individually, or in lots, to different investors 16. The transfer agreements give the investors 16 rights in the energy produced by their individually owned or leased PGUs 52. At the time of the transfer, the investors 16 also enter into sub-PPAs with the operating company 12. The sub-PPA guarantees the investor 16 a specified price, referred to herein as the retail offset, for the power generated from the PGUs 52 over a specified term (e.g., 20 years). In effect, the investors 16 agrees to sell back to the operating company 12 the power generated by PGUs 52. Thus, the operating company 12 can fulfill its obligations under the master PPA to supply the generated power to the utility company 12. The PPA and sub-PPA also provide a guarantee to the investor 16 of a predetermined return on the investment in the PGU 52.

Those skilled in the art will appreciate also that the utility company 14 may be the primary investor 18. The utility company 14 may establish the operating company 12 as a vehicle for the construction, sale, and/or leasing of individual PGUs 52. One advantage of this approach is that tax benefits and other benefits can be consolidated within the operating company 12 and the cost savings can be passed to individual investors. For example, there may be situations where the utility company is not eligible for some benefits. In this case, the utility company 14 could set up the operating company 12 as a way of claiming benefits.

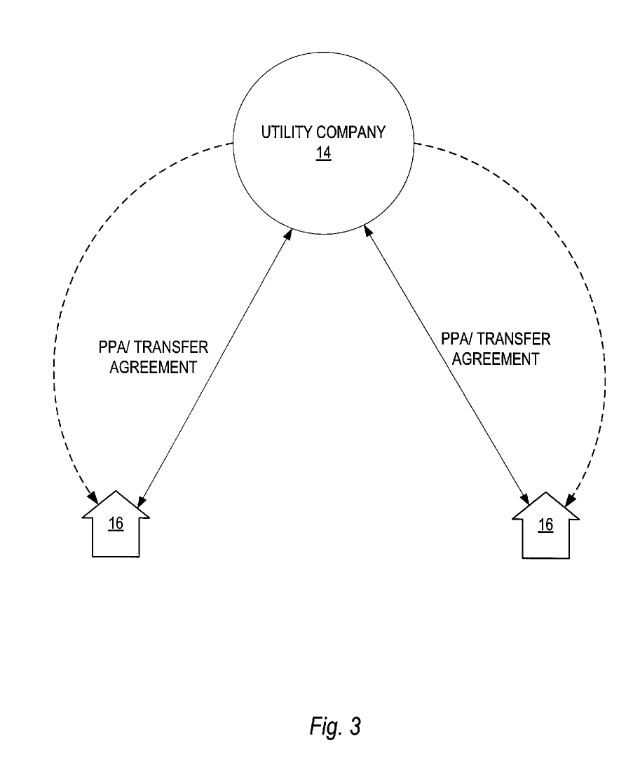

FIG. 3 illustrates an alternate method of financing and operating the REP 50. IN this embodiment, the utility company 14 constructs the REP 50 and sells or leases the PGUs 52 directly to the individual investors 16 without the operating company 12 as an intermediary. In this method, the utility company 14 also functions as the operating company 12. In this case, the utility company 14 may enter into a PPA directly with each investor 16. No master PPA is required since the utility company purchases power directly from the individual investors 16.

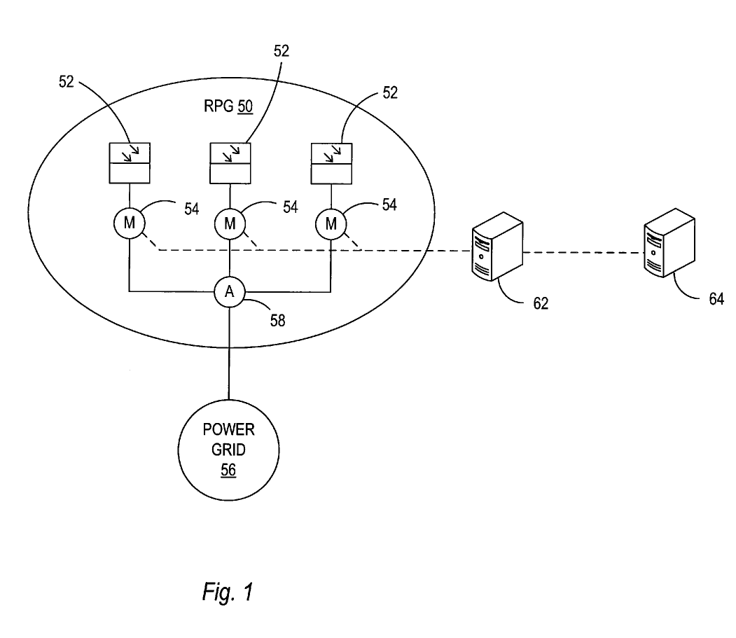

The REP 50 supplies power generated by the REP 50 to the public power grid 56. The amount of power contributed by each PGU 52 is individually measured and each investor 16 receives a corresponding retail offset based on the sub-PPA for the power generated from their respective PGUs 52. Alternatively, if an investor 16 purchases multiple PGUs 52, the operating company 12 could aggregate and measure the power generated by all of the PGUs 52 owned or controlled by a single investor 16. The central computer 62 (FIG. 1) keeps track of the power contributed to the public power grid 56 by each PGU 52. If the investors 16 are home owners or business operators that are connected to the power grid 56, the home owner or business operator may receive the retail offset in the form of a discount or offset on their electricity bill. The credit may be computed by an accounting server 64 based on power reports from the central computer 62.

The power reports will typically include an identification number associated with each PGU 52, and the amount of power that each PGU 52 contributed. The accounting server 64 may include a database that storing the identifying information (e.g., name, address, etc.) for each investor 16. The database links the investor identities with one or more specific PGUs 52 owned or leased by the investor 16. Thus, by matching the power generated for a given PGU 52 with the corresponding investor 16, the accounting server 62 is able to determine the credit due to each investor 16. The credits may be shown on the individual investor's billing statement so that the investor 16 can see the benefits of owning the PGU 52. The accounting server 64 may, in this case, be controlled and operated by the utility company 14.

The price paid for power by the utility company 14 includes a premium above the retail price of the power. For example, if the current retail price for power is $0.09 per kWh, the power purchase agreement may specify a purchase price of $0.19 per kWh; a $0.10 premium above the retail price of power. The utility company 14 is willing to pay the premium because it receives a renewable energy credit (REC) for the power purchased. The retail price for power will, of course, vary, based on geographic location. The premium paid by the utility company 14 for the power enables the primary investor 18 to obtain an acceptable return on the investment in the REP 50.

In addition to the amount paid by the utility company 14 for the power produced by the REP 50, the operating company 12 may receive investment tax credits (ITCs) from both state and federal governments. Also, the operating company 12 may be able to depreciate the assets. The ITCs and depreciation deductions effectively reduce the cost of building the REP 50 and make the REP 50 economically feasible. Further, these cost savings can be passed on to the individual investors 16, who may not otherwise be eligible to benefit from the ITCs and depreciation benefits.

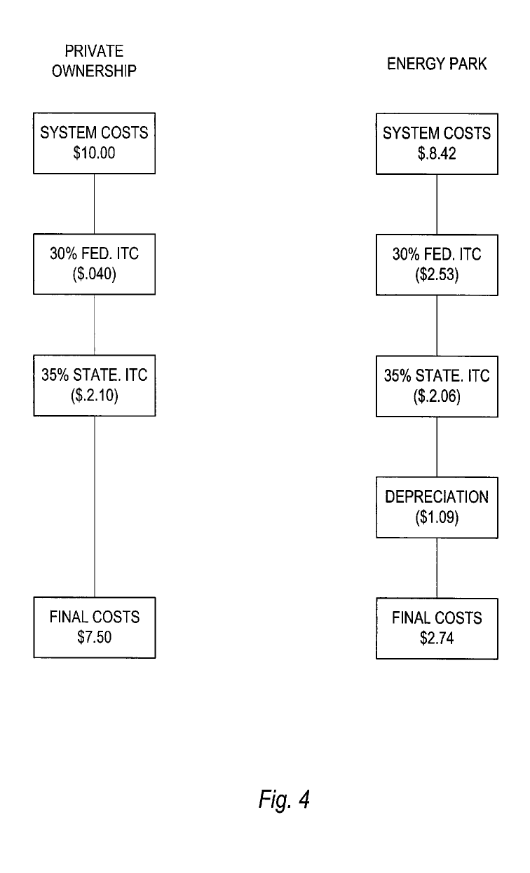

FIG. 4 illustrates compares the effective cost of a PGU 52 in the REP 50 to an individual investor 16 compared with the typical retail costs of a stand-alone system. The typical retail cost of a stand-alone 5 kWh system is shown on the left. It is assumed that the typical retail cost of building a 5 kwh system is $10 per watt. An individual investor building a 5 kWh unit is entitled to both state and federal ITCs. In this example, it is assumed that the individual investor 16 could receive a federal ITC of 30%, and a state ITC of 35% capped at $10,500. The savings for the individual investor 16 equals $0.40 per watt under the federal ITC and $2.10 per watt under the state ITC. Thus, the total effective cost to build the 5 kWh unit to an individual investor is $7.50 per watt.

The effective cost of building a 5 kWh PGU 52 in the REP 50 is shown on the right. The operating company 12 can build PGUs 52 at a much lower cost due to economies of scale. The cost savings from the economies of scale is about $1.58 per watt. It is assumed in this example that the applicable laws entitle the operating company 12 to a federal ITC of 30% and a state ITC of 35% capped at $2.5M. The savings equals $2.53 per watt for the federal ITC and $2.06 per watt for the state ITC. The operating company 12 is also eligible to depreciate the assets under federal and state tax laws. The depreciation benefit reduces the cost by $1.09 per watt. Thus, the total effective costs to build the 5 kWh unit under the business model 10 is $2.74 per watt. These numbers are for demonstration purposes only and will vary based on several key factors, most importantly the total size of the REP 50.

As shown in FIG. 4, an individual investor 16 can purchase a PGU 52 from the operating company 12 at a much lower cost than the investor can build one on his own. The cost reduction makes it financially feasible for more consumers to invest in solar or wind power. Additionally, the fact that the PGUs 52 are located at a large scale facility vastly increases the market for solar and wind PGUs 52. Persons that could not build a stand-alone unit due to site constraints can purchase a PGU 52 in the REP 50.

It is contemplated that the operating company 12 may need to retain ownership of the PGUs 52 for a period of 5 years to fully realize the benefit of depreciation of the PGUs 52. Therefore, the operating company 12 may enter into a lease/purchase agreement with the individual investor 16. The lease purchase agreement gives the rights in the energy generated by the leased PGU 52 for the term of the lease to the individual investor 16. As noted above, the investor 16 signs a sub-PPA to sell the power back to the operating company 12. The individual investor 16 is also given the right to purchase the PGU 52 at the end of the lease for a specified amount. The lease of the PGU 52 to the individual investor 16 is preferably structured so as to be revenue neutral to the operating company 12, the primary investor 18, and the individual investor 16 during the term of the lease. For example, a lease may be structured so that the lease payments from the investor 16 for the first five years roughly equal the retail offset given to the individual investor 16 under the sub-PPA. The purchase price of the PGUs 52 at the end of the lease term must satisfy three requirements: (1) fulfilling the contractual obligations to the utility company 14 under the master PPA; (2) fulfilling financial expectations of the primary investor 18 and operating company 14; and (3) providing an attractive alternative energy source to the individual investors 16.

Assuming that the real cost of building the PGU 52 is $8.42 and that the effective cost to the operating company 12 after tax benefits is $2.74 per watt, a reasonable resale price of the PGU 52 at the end of the lease would be around approximately $3.28 per watt or approximately $16,400.00 for a 5 kWh PGU 52. This price includes the transfer to the investor 16 of the entire $0.19/kWh rate paid by the utility company 14. This price generates a gross margin from the resale of about $0.54/watt, which provides an attractive return on investment to the primary investor 18 and/or the operating company 12. This margin creates an additional return on top of the traditional 8% return calculated into the initial $0.19/kWh master PPA agreement. The purchase option also provides an attractive alternative to the individual investor when compared to the retail cost of installing an individual solar unit to a retail customer. Under the lease/purchase agreement, the retail customer has the option to purchase the PGU 52 for a cost of $3.28/watt compared to the upfront cost of $10.00/watt for a unit purchased at retail. Also, the master PPA and sub-PPA guarantee the investor 16 a minimum return on the investment over the remaining term of the master PPA. This return is equal to the net present value (NPV) of the remaining cash flows generated by the $0.19 per kWh that the individual investor 16 is entitled to upon purchase of the PGU 52. Therefore, the PGU 52 will cost less than a conventional system and provide greater value because the electricity it produces will be worth more. Simply put, the PGU 52 will provide greater output that is worth more than a stand-alone system.

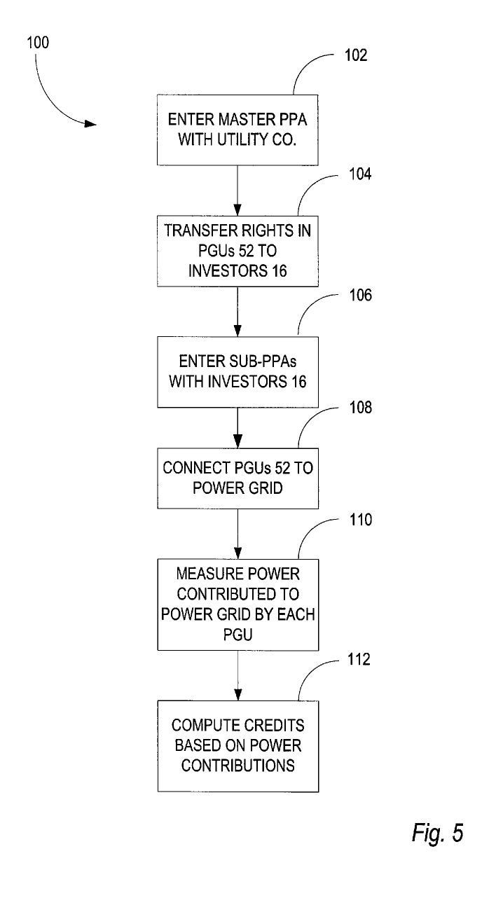

FIG. 5 illustrates an exemplary method 100 for operating the REP 50 according to one embodiment. The operating company 12 enters into a master PPA with a utility company 14 to supply power generated by PGUs 52 at the REP 50 (block 102). The master PPA will typically be entered prior to the time that the REP 50 is constructed. Either before or after the REP 50 is constructed, the operating company 12 transfers rights in the individual PGUs 52 in the REP 50 to individual investors 16 (block 104). The transfer agreements give the investors 16 rights in the energy produced by their individually owned or leased PGUs 52. At the time the PGUs 52 are transferred, the operating company 12 also enters into sub-PPAs with the investors 16 (block 106). The sub-PPAs allow the operating company to purchase the output of the PGUs 52 in exchange for a guaranteed retail offset paid to the investors 16.

The operating company 12 connects the individual PGUs 52 to a power grid 56 maintained by the utility company 14 and supplies power generated by individual PGUs 52 in said REP 50 to the public power grid 56 (block 108). As previously described, a separate power meter 54 may be installed to measure the power contributed by each PGU 52. The power contributed by each PGU 52 to the power grid 56 is measured and the data is stored in the central computer 62 to enable accounting to the investors 16 for the power contributed by their respective PGUs 52 (block 110). The investors 16 receive retail offset for the power contributed to the power grid 56 by their respective PGUs 52. The operating company 12, utility company 14, or third party may operate an accounting server 64 to calculate the retail offset due to each investor 16 based on the amount of power contributed to the power grid 56 by each investor's PGU 52 (block 112). The retail offset may be given to the investor 16, for example, as a credit or discount on the investor's electrical bill or in the form of a direct payment or dividend.

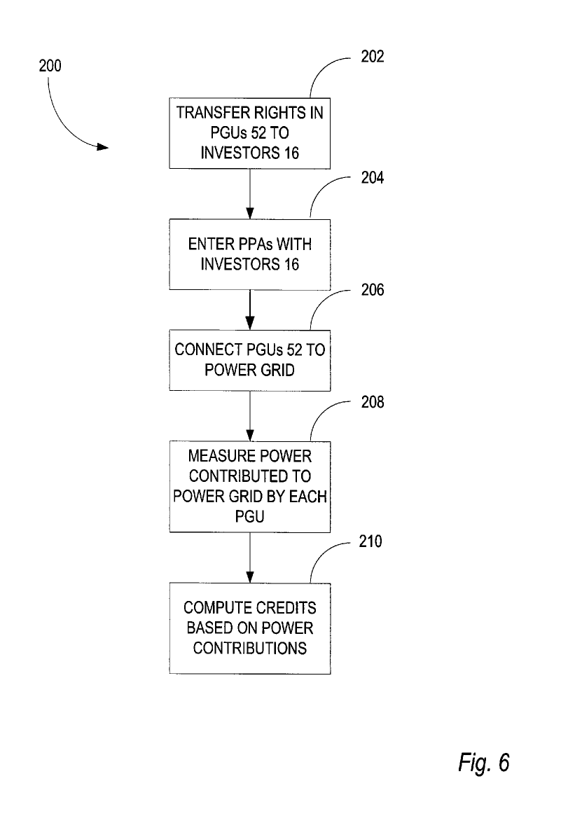

FIG. 6 illustrates an alternate method 200 of operating a REP 50 by a utility company 14. In this embodiment, it is assumed that the REP 50 is initially financed and constructed by the utility company 14. Either before or after the REP 50 is constructed, the utility company 14 transfers rights in the individual PGUs 52 in the REP 50 to individual investors 16 (block 202). The transfer agreements give the investors 16 rights in the energy produced by their individually owned or leased PGUs 52. At the time the PGUs 52 are transferred, the utility company 14 also enters into PPAs with the investors 16 (block 204). The PPAs allow the utility company 14 to purchase the output of the PGUs 52 in exchange for a guaranteed retail offset paid to the investors 16.

The utility company 12 connects the individual PGUs 52 to a power grid 56 maintained by the utility company 14 and supplies power generated by individual PGUs 52 in said REP 50 to the public power grid 56 (block 206). As previously described, a separate power meter 54 may be installed to measure the power contributed by each PGU 52. The power contributed by each PGU 52 to the power grid 56 is measured and the data is stored in the central computer 62 to enable accounting to the investors 16 for the power contributed by their respective PGUs 52 (block 208). The investors 16 receive retail offset for the power contributed to the power grid 56 by their respective PGUs 52. The utility company 14 or third party may operate an accounting server 64 to calculate the retail offset due to each investor 16 based on the amount of power contributed to the power grid 56 by each investor's PGU 52 (block 210). The retail offset may be given to the investor 16, for example, as a credit or discount on the investor's electrical bill or in the form of a direct payment or dividend.

For individual investors 16 seeking to offset their carbon footprint and set an example in their community, the renewable energy power generation model offers clean, reliable solar and wind energy that is less expensive than traditional solar and wind installations. Unlike traditional roof-managed solar arrays on individual homes and businesses, ownership of a solar or wind PGU 52 in a large-scale REP 50 eliminates the need for costly custom design and engineering, which greatly reduces cost and speeds installation. Customers can purchase one or more power generation units in a large-scale solar facility that is maintained by professional staff while receiving all of the benefits attributable to ownership of the PGU 52.

Owners of existing homes and properties can purchase PGUs 52 directly from the operating company 12. Because the systems are already engineered, the purchased PGUs 52 can be installed and operating within 30 days. Home builders can purchase PGUs 52 for resale along with a new home to create additional incentive to prospective home owners to purchase homes from the builder. In this case, the cost of the PGU 52 can be included in the cost of the home and financed along with the home. Because the energy costs for the new home will be offset by the credits received for power contributed to the public grid 56, the homeowner can expect to have low electricity bills.

In some embodiments, the PGUs 52 can be purchased by a single investor and resold. For example, a large investor such as a bank or other financial institution could purchase all or a substantial part of the PGUs 52 at the REP 50 and resell the PGUs 52 to individual investors. The original investor in this case could offer various ways to finance the purchase, such as lease options, to the individual investors.

The public utility companies also benefit by gaining access to renewable energy that diversifies their power portfolios and provides renewable energy credits to meet RPS requirements at a lower cost than comparable models and, in some cases, without any up-front investment. In the case of solar power facilities, the generating assets are highly efficient during peak hours.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of operating a renewable energy park having a plurality of commonly managed, power generation units for generating power from renewable energy sources, said method comprising:
entering into a master power purchase agreement with a utility company to sell power generated by said power generation facility to said utility company for a first negotiated price;
transferring rights in individual power generation units to two or more individual investors;
entering into subsidiary power purchase agreements with said individual investors to purchase power generated by said individual power generation units for a second negotiated price;
supplying power generated by said power generation units to a public power grid; and
individually measuring power supplied to the public power grid by said individual power generation units to enable accounting to said individual investors for the power contributed by their respective power generation units.

2. The method of claim 1 wherein transferring rights in individual power generation units to one or more individual investors comprises leasing one or more individual power generation units to one or more individual investors.

3. The method of claim 2 wherein entering into subsidiary power purchase agreements with said investors to purchase power generated by said individual power generation units for a second negotiated price comprises allocating a portion of the first negotiated price to said investor as the second negotiated price in the subsidiary power purchase agreement.

4. The method of claim 2 wherein leasing one or more individual power generation units to one or more individual investors comprising leasing one or more individual power generation units to said individual investors for a predetermined lease period with an option exercisable by said individual investors to purchase the individual power generation units at the end of the lease period.

5. The method of claim 1 wherein transferring rights in individual power generation units to one or more investors comprises transferring by sale title in one or more individual power generation units to one or more individual investors.

6. A power generation facility comprising:
a plurality of power generation units co-located at a power generation facility and connected to a public power grid for generating power from a renewable energy source;
a plurality of individual power meters for individually measuring the power contributed to the public power grid by each one of the co-located power generation units; and
a computer configured to store said power measurements, to monitor the total power contributed to the public power grid by all of said power generation units, and to account to individual owners of said power generation units for the power contributed by their respective power generation units.

7. A method of operating a renewable energy park having a plurality of commonly managed, power generation units for generating power from renewable energy sources, said method comprising:
transferring rights in individual power generation units to two or more individual investors;
entering into power purchase agreements with said individual investors to purchase power generated by said individual power generation units;
supplying power generated by said power generation units to a public power grid; and
individually measuring power supplied to the public power grid by said individual power generation units to enable accounting to said individual investors for the power contributed by their respective power generation units.

8. The method of claim 7 wherein transferring rights in individual power generation units to one or more individual investors comprises leasing one or more individual power generation units to one or more individual investors.

9. The method of claim 8 wherein leasing one or more individual power generation units to one or more individual investors comprising leasing one or more individual power generation units to said individual investors for a predetermined lease period with an option exercisable by said investors to purchase the individual power generation units at the end of the lease period.

10. The method of claim 7 wherein transferring rights in individual power generation units to one or more investors comprises transferring by sale title in one or more individual power generation units to one or more individual investors.
